(19) United States
(12) Patent Application Publication
(10) Pub. No.: US 2012/0115367 A1
(43) Pub. Date: May 10, 2012

(54) METHOD FOR INTEGRATING AND ERECTING CARBON NANOTUBE COLUMN

(75) Inventors: YEN-CHIH CHANG, New Taipei (TW); CHIH-PI CHENG, New Taipei (TW)

(73) Assignee: HON HAI PRECISION INDUSTRY CO., LTD., New Taipei (TW)

(21) Appl. No.: 13/292,050

(22) Filed: Nov. 8, 2011

(30) Foreign Application Priority Data
Nov. 8, 2010 (TW) 099138282

(51) Int. Cl. H01R 24/20; C25D 1/14; B82Y 99/00; B82Y 40/00

(52) U.S. Cl. 439/626; 204/477; 977/742; 977/842

(57) ABSTRACT

A method for integrating and erecting CNT column, comprises following steps of: 1) providing a conductive layer; 2) applying a non-conductive layer over the conductive layer; 3) forming a via on the non-conductive substrate; 4) placing an electrode above the via; 5) deploying dispersive liquid containing CNT powder into the via; 6) applying a predetermined AC electric field between the conductive substrate and the electrode for integrating and erecting the CNT powder into CNT column under electric field force.

### BACKGROUND OF THE INVENTION

1. Field of the Invention

The present invention relates to a method for integrating carbon nanotube column, and more particularly to a method using vertical electricfield for integrating carbon nanotube column thus achieving erect nanotube column.

2. Description of the Prior Art

Since carbon nanotube (CNT) was discovered and reported by Japanese physical spiciest Sumio Iijima in 1991, the physical and electrical properties of the CNT is more and more appreciated by the industry as more and more genuine applications are introduced.

However, the CNT must be integrated/assembled before it is used in a certain application. At present, a conventional method called dielectrophoresis (DEP) is used to integrate the CNT into an unitary structure. As shown in FIG. 1, the conventional method uses two electrodes disposed on a same side of a substrate and spaced to each other. Dispersive liquid with CNT powder will be dropped into a cavity disposed between the two electrodes. When an AC electric field is applied between the two electrodes, the CNT powder will be integrated into CNT column under electric field force. Such CNT column is suit for some applications, e.g., chemical sensor, but is not suit for application which needs the CNT having a three-dimensional structure. For example, contact of electrical connector for connecting Integrated Circuit (IC) package usually needs a three-dimensional structure. Therefore, the CNT art is hard to be used in electrical connector field.

U.S. Pat. No. 6,626,684 issued to Stickler on Sep. 30, 2003 disclosed a nanotube socket system using three-dimensional nanotube column for transmitting electric signal. However, Stickler is silent on how to integrate the nanotube into CNT-column.

Therefore, it is needed to find a new method to overcome the problems mentioned above.

### SUMMARY OF THE INVENTION

Accordingly, an object of the present invention is to provide a method for integrating nanotubes column, and more particularly to a method using vertical electric field for integrating and erecting nanotubes column thus achieving erect nanotubes column which can be used in electric socket field.

In order to achieve the object set forth, a method for integrating and erecting CNT column, comprises following steps of: 1) providing a conductive layer; 2) applying a non-conductive layer over the conductive layer; 3) forming a via on the non-conductive substrate; 4) placing an electrode above the via; 5) deploying dispersive liquid containing CNT powder into the via; 6) applying a predetermined AC electric field between the conductive substrate and the electrode for integrating and erecting the CNT powder into CNT column under electric field force.

### BRIEF DESCRIPTION OF THE DRAWINGS

FIG. 1 is a sketch view of a conventional method for integrating CNT;

FIG. 2 shows a schematic diagram of a method for integrating and erecting CNT column of the present invention;

FIG. 3A and FIG. 3B shows an integrate process for integrating CNT by using the method of the present invention in accordance with a first preferred embodiment;

FIG. 4 is a photograph of a CNT-column made by the method of the present invention.

FIG. 5A and FIG. 5B shows an integrate process for integrating CNT by using the method of the present invention in accordance with a second preferred embodiment;

FIG. 6 is an isometric view of an electrical socket of the present invention in accordance with the second preferred embodiment; and

FIG. 7 is an exploded view of the electrical socket shown in FIG. 6.

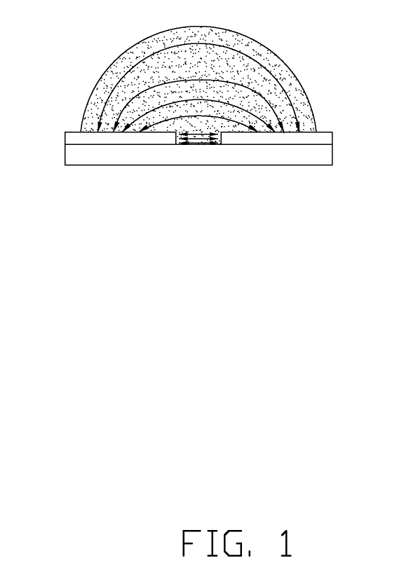

### DESCRIPTION OF PREFERRED EMBODIMENT

Reference will now be made to the drawings to describe the present invention in detail.

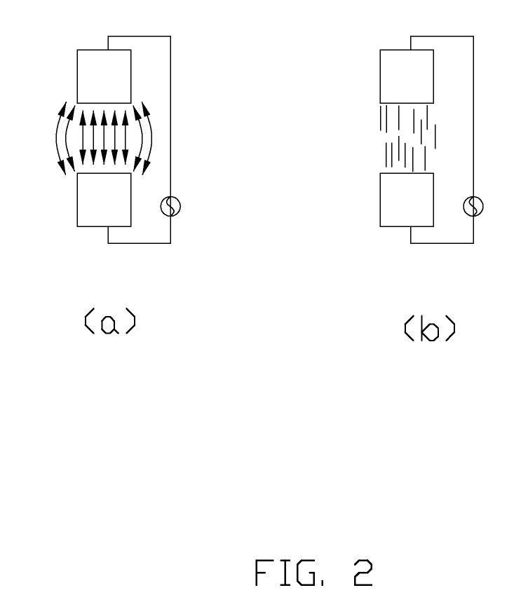

Referring to FIG. 2(a)-(b), schematic diagram of the present invention is shown. As we know, when an AC electric field is applied between two electrodes, the CNT powder will be moved under electric field force along direction of the electric field. Such phenomenon is called dielectrophoresis (DEP).

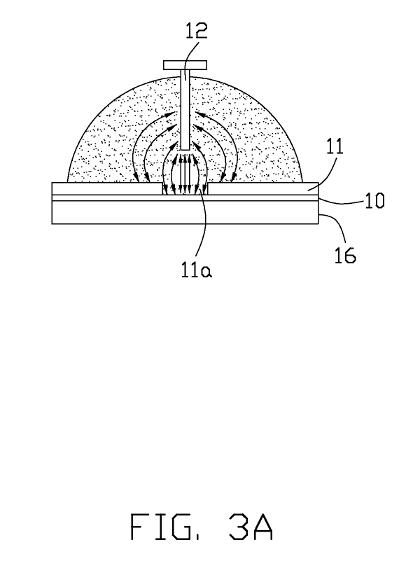

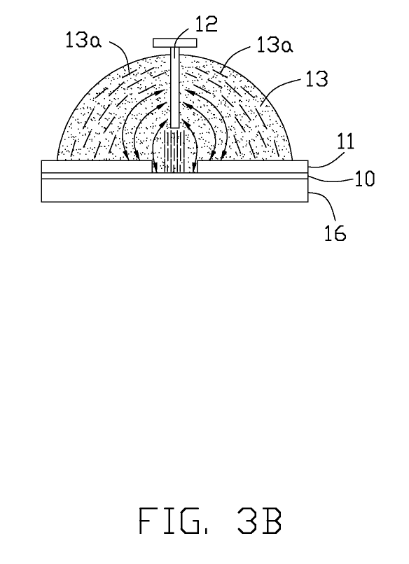

Referring to FIGS. 3A-3B, a method called vertical DEP in accordance with a first preferred embodiment of the present invention is shown, which uses vertical electric field to integrate and erect CNT powder into CNT columns with erect structure. According to the method, firstly, a base substrate 11 is provided with a number of vias 11a (only one is shown). The vias 11a are arranged in a manner of matrix or other layout. Then, a first electrode 10 and a second electrode 12 is disposed at two sides of the base substrate 11 respectively and corresponding to a via 11a. According to a preferred embodiment of the present invention, the base substrate 11 is made from non-conductive matters. The first electrode 10 is a substrate made from gold and covering on a lower surface of the substrate 11. Specially, the first electrode 10 and the base substrate 11 is disposed on a surface of a wafer 16. The second electrode 12 is a conductor and of an acicular or columnar shape. According to the preferred embodiment of the invention, diameter of the second electrode 12 is smaller than that of the via 11a, so as to control diameter of the CNT column, which will be erected. The second electrode 12 has a plate structure on a top end thereof for pulling up dispersive liquid 13 containing CNT powder 13a to form liquid column, thus increasing volume of the dispersive liquid 13 and the number of CNT powder 13a involved/used in the vertical DEP process. In the preferred embodiment of the present invention, only one second electrode 12 is shown. In fact, number of the second electrode 12 is equal to number of the vias 11a.

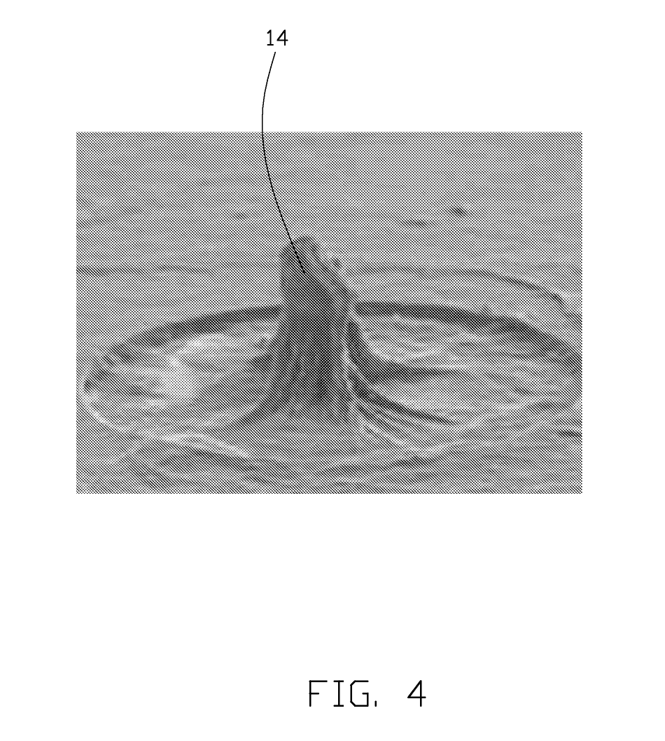

Thirdly, the dispersive liquid 13 having CNT powder 13a will be dropped into the via 11a. Preparation of the dispersive liquid 13 will be described later. At last, an AC electric field is applied between the first electrode 10 and the second electrode 12. Accordingly, the CNT powder 13a contained in the dispersive liquid 13 will be integrated and erected into a CNT column 14 (as shown in FIG. 4) under electric field force.

As shown in FIG. 4, the CNT column 14 formed from the vertical DEP solution is of an erect structure and can be used in more application, e.g. electrical connector field. Contrarily, CNT column from the conventional DEP art has a sheet structure and has a limited application.

In the preferred embodiment, preparation of the dispersive liquid 13 comprises steps of mixing and dispersing the CNT powder 13a into a miscible liquid which is consisted of 50% distilled water in volume and 50% alcohol in volume, and a process of ultrasonic shock wash 1.5 hours. According to the preferred embodiment, ratio by volume of the water and alcohol may be between 1:1 and 1:3. Moreover, because volume and quality of the CNT powder 13a are very small, molecular force between the CNT powder 13a may becomes strong during process of the CNT powder 13a mixed and dispersed into the miscible liquid containing distilled water and alcohol, which will make the CNT powder 13a easily intertwined. Therefore, before the actual mixed and dispersed process of the application, the best to be addressed, the CNT powder 13a are experienced a process of acid treatment. The acid treatment is a known art and uses nitric acid and sulphuric acid for purifying the CNT powder 13a. Use of the aforementioned dispersive way of CNT powder, can achieve a very good dispersive result.

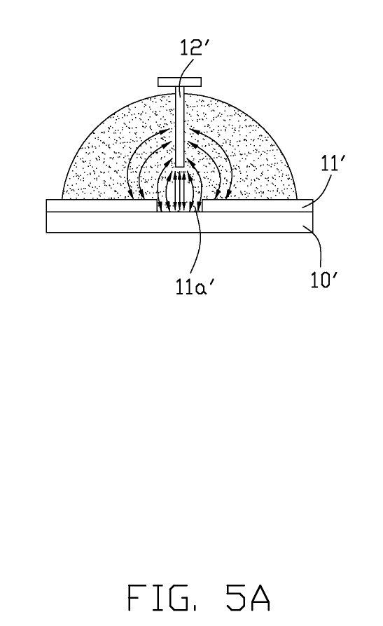

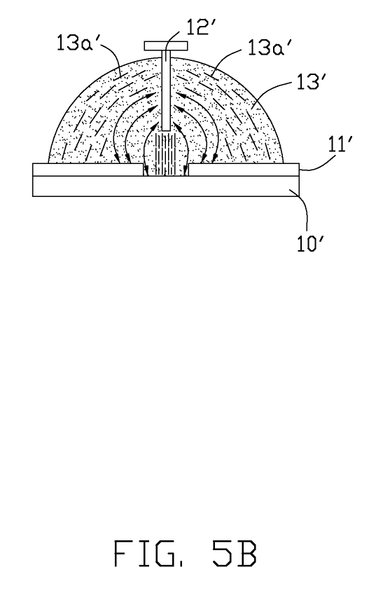

Referring to FIGS. 5A-5B, a method called vertical DEP in accordance with a second preferred embodiment of the present invention is shown, which uses vertical electric field to integrate and erect CNT powder into CNT columns with erect structure. According to the method, firstly, a base substrate 11′ is provided with a number of vias 11a′ (only one is shown). The vias 11a′ are arranged in a manner of matrix or other layout. Then, a first electrode 10 and a second electrode 12′ is disposed at two sides of the base substrate 11′ respectively and corresponding to a via 11a′. According to a preferred embodiment of the present invention, the base substrate 11′ is made from non-conductive matters. The first electrode 10′ is a substrate made from gold and covering on a lower surface of the substrate 11′. The second electrode 12′ is a conductor and of an acicular or columnar shape. According to the preferred embodiment of the invention, diameter of the second electrode 12′ is smaller than that of the via 11a′, so as to control diameter of the CNT column, which will be erected. The second electrode 12′ has a plate structure on a top end thereof for pulling up dispersive liquid 13′ containing CNT powder 13a′ to form liquid column, thus increasing volume of the dispersive liquid 13′ and the number of CNT powder 13a′ involved/used in the vertical DEP process. In the preferred embodiment of the present invention, only one second electrode 12′ is shown. In fact, number of the second electrode 12′ is equal to number of the vias 11a′.

Thirdly, the dispersive liquid 13′ having CNT powder 13a′ will be dropped into the via 11a′. Preparation of the dispersive liquid 13′ will be described later. At last, an AC electric field is applied between the first electrode 10 and the second electrode 12′. Accordingly, the CNT powder 13a′ contained in the dispersive liquid 13′ will be integrated and erected into a CNT column 14 (as shown in FIG. 4) under electric field force.

As shown in FIG. 4, the CNT column 14 formed from the vertical DEP solution is of an erect structure and can be used in more application, e.g. electrical connector field. Contrarily, CNT column from the conventional DEP art has a sheet structure and has a limited application.

In the preferred embodiment, preparation of the dispersive liquid 13′ comprises steps of mixing and dispersing the CNT powder 13a′ into a miscible liquid which is consisted of 50% distilled water in volume and 50% alcohol in volume, and a process of ultrasonic shock wash 1.5 hours. Moreover, because volume and quality of the CNT powder 13a′ are very small, molecular force between the CNT powder 13a′ may becomes strong during process of the CNT powder 13a′ mixed and dispersed into the miscible liquid containing distilled water and alcohol, which will make the CNT powder 13a′ easily intertwined. Therefore, before the actual mixed and dispersed process of the application, the best to be addressed, the CNT powder 13a′ are experienced a process of acid treatment. The acid treatment is a known art and uses nitric acid and sulphuric acid for purifying the CNT powder 13a′. Use of the aforementioned dispersive way of CNT powder, can achieve a very good dispersive result.

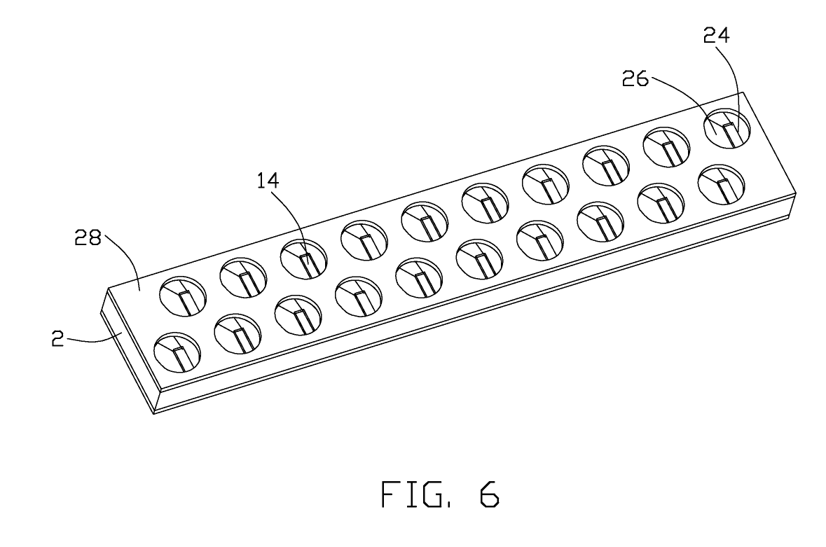

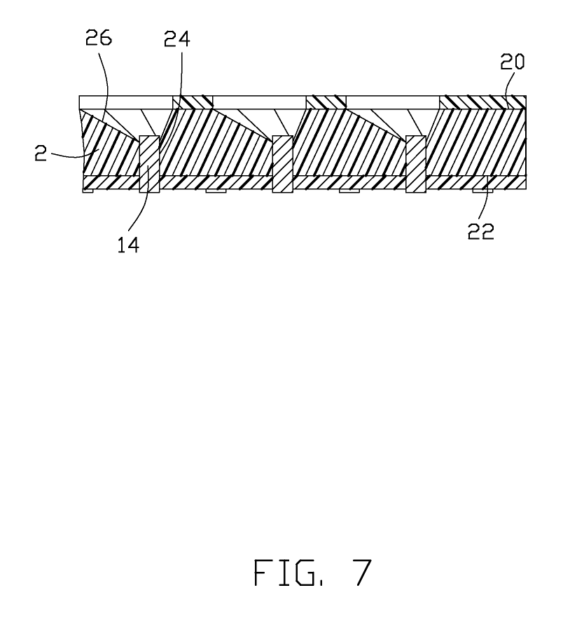

Method for integrating and erecting CNT column can be used in electrical socket field for making an electrical socket. Referring to FIGS. 6-7, firstly, an insulative substrate 2 will be provided. The insulative substrate 2 has opposite upper surface 20, lower surface 22 and a number of through holes 24 extending through both the surfaces. Then, the first electrode 10′ and the second electrode 12′ will be disposed at two sides of the insulative substrate 2 respectively and corresponding to a through hole 24. Thirdly, the dispersive liquid 13′ having CNT powder 13a will be dropped into the through hole 24. At last, an AC electric field is applied between the first electrode 10′ and the second electrode 12′. Accordingly, the CNT powder 13a′ contained in the dispersive liquid 13′ will be integrated and erected into a CNT column 14 along the through hole under electric field force. Accordingly, an electrical socket having CNT structure is provided.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. A method for integrating and erecting CNT column, comprising:
providing a conductive layer;
applying a non-conductive layer over the conductive layer;
forming a via on the non-conductive layer;
placing an electrode above the via;
deploying dispersive liquid containing CNT powder into the via; and
applying a predetermined AC electric field between the conductive substrate and the electrode for integrating and erecting the CNT powder into CNT column under electric field force.

2. The method as claimed in claim 1, wherein the conductive layer is made from gold.

3. The method as claimed in claim 1, wherein the conductive layer and the non-conductive layer is placed on an upper surface of a wafer.

4. The method as claimed in claim 1, wherein preparation of the dispersive liquid is formed by mixing the CNT powder into a miscible liquid consisted of water and alcohol.

5. The method as claimed in claim 4, wherein ratio by volume of the water and alcohol is between 1:1 and 1:3.

6. The method as claimed in claim 4, wherein the water is distilled water.

7. The method as claimed in claim 4, wherein the CNT powder are experienced a processes of acid treatment before it is mixed into the miscible liquid containing water and alcohol.

8. The method as claimed in claim 1, wherein the electrode is of an acicular shape.

9. The method as claimed in claim 8, wherein the electrode is provided with a plate structure on a top end thereof.

10. A method for integrating and erecting CNT column, comprising:
providing an insulative substrate, the insulative substrata having an upper surface, a lower surface and at least one through hole through both the surfaces;
placing a first electrode above upper surface and a second electrode below the lower surface, the first electrode and the second electrode being arranged corresponding to the through hole;
dropping dispersive liquid containing CNT powder into the through hole; and
applying a predetermined AC electric field between the conductive substrate and the electrode for integrating and erecting the CNT powder into CNT column under electric field force along the through hole.

11. The method as claimed in claim 10, wherein preparation of the dispersive liquid is formed by mixing the CNT powder into a miscible liquid consisted of water and alcohol.

12. The method as claimed in claim 11, wherein ratio by volume of the water and alcohol is between 1:1 and 1:3.

13. The method as claimed in claim 11, wherein the water is distilled water.

14. The method as claimed in claim 11, wherein the CNT powder are experienced a processes of acid treatment before it is mixed into the miscible liquid containing water and alcohol.

15. The method as claimed in claim 10, wherein the upper surface of the insulative substrate defines a guiding slot communicated with the through hole.

16. The method as claimed in claim 15, wherein the guiding slot is gradually reduced along an upper-to-lower direction.

17. An electrical connector comprising:
an insulative substrate defining opposite upper and bottom surfaces thereon;
upper and bottom layers applied upon the upper and bottom surfaces, respectively;
a plurality of passageways defined in the substrate, each of said passageways including an upper funnel section extending through the upper layer and a lower slit section extending through the lower layer; and
a carbon nanotube applied upon and filled within the lower slit section; wherein
an upper end of the carbon nanotube extending upwardly beyond an upper end of the lower slit section and into the upper funnel section, a lower end of the carbon nanotube extending downwardly beyond a lower end of the lower slit section.

18. The electrical connector as claimed in claim 17, wherein the lower end of the carbon nanotube extending downwardly beyond the lower layer.

19. The electrical connector as claimed in claim 17, wherein the upper tunnel section is asymmetrically arranged with regard to the corresponding lower slit section below.

20. The electrical connector as claimed in claim 17, wherein the carbon nanotube is formed via electric filed force.
